(19) United States
(12) Patent Application Publication
(10) Pub. No.: US 2021/0172135 A1
(43) Pub. Date: Jun. 10, 2021

(54) Traffic Safety Device Placement Apparatus

(71) Applicant: COP Construction, LLC, North Salt Lake, UT (US)

(72) Inventor: Mike Bazzano, North Salt Lake, UT (US)

(73) Assignee: COP Construction, LLC, North Salt Lake, UT (US)

(21) Appl. No.: 16/706,767

(22) Filed: Dec. 8, 2019

(51) Int. Cl. E01F 15/04; E01F 15/08; E01F 15/14; E01F 9/669; E01F 15/02

(52) U.S. Cl. CPC E01F 15/043; E01F 15/083; E01F 15/088; E01F 9/669; E01F 15/025; E01F 15/143

(57) ABSTRACT

A traffic safety device placement apparatus that permits the placement of traffic safety devices with reduced labor requirements and increased safety measures. Traffic safety devices can be moved into or out of the roadway without the need for anyone being exposed to traffic and can be placed much more quickly than previously known devices.

### FIELD OF THE INVENTION

The present invention relates to a device for placing and retrieving traffic safety barrels, cones or other objects used in association with road construction and maintenance projects.

### BACKGROUND OF THE INVENTION

Road construction companies use roadway markers in multiple applications that require a non-permanent direction of the traffic of vehicles on a roadway. For instance, roadway markers are utilized on road construction sites to direct the traffic of vehicles in alternative routes. Of critical importance, roadway markers, such as traffic barrels, are utilized to protect construction workers and to direct traffic safely away from construction zones.

One of the significant problems faced by construction workers that are working on highway and roadway construction projects is remaining safely separated from traffic. During such projects, safety barrels, cones or other objects are used to warn and alert drivers of the construction work and presence of construction workers and equipment, redirect traffic in the event of lane and ramp closures, and to protect workers. When active construction is not happening, the barrels used to separate a construction zone from the flow of traffic are placed out of the flow of traffic on the shoulder of the road. The barrels, or other roadway markers, are then moved out into the flow of traffic before construction work commences.

Historically, the job of moving barrels or other safety devices into or out of the road has been accomplished manually by one or more workers who walk along the highway and move the barrels from the shoulder to the highway or from the highway to the shoulder. The safety barrels weigh up to 30 pounds and moving them into or out of position manually can be a very time-consuming and labor-intensive task especially when the barrels need to be placed along miles of a highway. In addition, the individuals who are moving the barrels are exposed to vehicles moving at a high rate of speed and subject to an increased chance of injury occurring. Unfortunately, many individuals placing traffic safety devices have been injured or killed as they are doing their jobs.

In order to avoid some of the problems with manually moving the barrels, construction workers would drive a truck along the highway and other workers would move the barrels. This eliminated some of the problems with barrel placement taking so much time and increased the safety for the barrel movers. However, it still required a significant amount of labor and took a significant amount of time. Workers were required to operate out of the back of a moving vehicle raising safety concerns.

In U.S. Pat. No. 9,957,143 and U.S. Pat. Pub. No. 2005/0196257, the applicants attempted to address the issues of labor and time consumption with a device that attaches to the front of a vehicle. It is essentially an angled boom that would make contact with a barrel that would then move along the boom to its desired placement location. The'143 patent added rollers to the boom to aid with the movement of the barrels. Both devices require modification to an existing vehicle, must be driven at relatively slow speeds or the barrels would simply be crushed or moved in an undesired direction, and require that the driver move in a zigzag direction to properly capture and move the barrels.

There is a need for a more efficient device and method for placing traffic safety devices. There is a need for a device that minimizes the number of workers required to move the traffic safety devices, allows for quicker placement of the traffic safety devices, protects the safety of those placing the devices and can be attached to a vehicle without requiring modification of the vehicle. Others have attempted to address this problem with

### SUMMARY OF THE INVENTION

The present invention has been accomplished to provide an improved traffic safety barrier placement device.

According to the present invention, there is provided traffic safety barrier placement apparatus, which is generally comprised of a device for attaching the apparatus to an existing hitch on the rear of a vehicle, a receiving end for capturing a traffic safety barrier, a channel for moving the traffic safety barrier and an exit for depositing the traffic safety barrier in a desired location. Upon movement of the vehicle to which the present invention is attached, the driver approaches, for example, a traffic barrel. The receiving end of the present invention captures the traffic barrel, which then enters the barrel channel and moves to the opposite side of the vehicle and the receiving end where it then encounters the barrel exit location and is deposited at the desired location along the highway.

In one aspect of the invention, it provides an apparatus that can be easily retrofitted to any vehicle with a hitch.

In another aspect of the invention, it provides an apparatus that allows a single worker to move traffic safety barrier to a desired location into or out of a roadway.

In another aspect of the invention, it provides increased safety to a worker who is placing traffic safety barriers as the worker can remain within the passenger space of the vehicle to which the present invention is attached while the traffic safety barriers are being placed.

In another aspect of the invention, the worker operating the vehicle placing traffic safety barriers can drive the vehicle parallel to the roadway while placing the barriers.

In another aspect of the invention, it provides an apparatus that minimizes the fatigue on construction workers and allows them to safely install and uninstall traffic control devices without being in the travel lanes of traffic.

In another aspect of the invention, it provides an apparatus that can be adjusted to control the exact point of placement of the traffic control devices to ensure placement accuracy.

To the accomplishment of the above and related aspects, the invention may be embodied in the form illustrated in the accompanying drawings. The drawings, however, are illustrative only. Variations are contemplated as being part of the invention, limited only by the scope of the claims.

### BRIEF DESCRIPTION OF THE DRAWINGS

FIG. 1 is a side perspective view of the present invention.

FIG. 2 is another side perspective view of the present invention.

FIG. 3 is a top view of the present invention.

FIG. 4 is a side perspective view of the present invention deployed on a vehicle.

FIG. 5 is a top view of the present invention deployed on a vehicle.

### DETAILED DESCRIPTION OF THE INVENTION

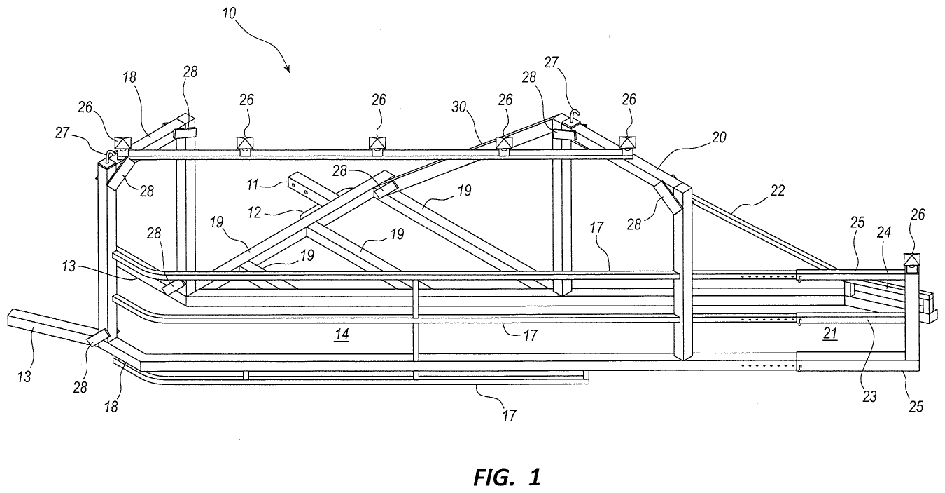

As shown in the accompanying drawings, this is a traffic safety device placement apparatus. FIG. 1 show a side perspective view of traffic safety device placement apparatus 10 and includes hitch attachment 11 and hitch attachment reinforcement plate 12, which are used to connect traffic safety device placement apparatus 10 to the existing hitch on a vehicle. Hitch attachment 11 is connected to horizontal supports 19, which attach to interior guide rail 15. After traffic safety device placement apparatus 10 is attached to a vehicle, the driver would approach a traffic safety device, such as a traffic barrel, so that the traffic barrel would encounter intake guides 13, which would direct the traffic barrel through entry gate 18 into guide chute 14. Guide chute 14 is defined by interior guide rail 15 and exterior guide rail 16. Interior support rails 17 help stabilize the traffic barrel when it passes through guide chute 14. The traffic barrel then passes through exit gate 20 into ejection chute 21. Ejection chute 21 is defined by exterior guide rail 16, interior guide rail 15, ejection guide support 22, outer support rails 23, and ejection guide 24. Ejection chute guide 25 is adjustably attached to the outer end of exterior guide rail 16 and outer support rails 23 and can be adjusted according to the desired final placement of the traffic barrels. Ejection guide 24 can also be adjusted according to the desired final placement of the traffic barrels. Safety lights 26 are affixed to upper portions of traffic safety device placement apparatus 10. Strap support hooks 27 are provided in case there is a need to attach straps between traffic safety device placement apparatus 10 and the vehicle to which it is attached for leveling or support purposes. Connection reinforcements 28 provide additional support to potential high stress areas of traffic safety device placement apparatus 10.

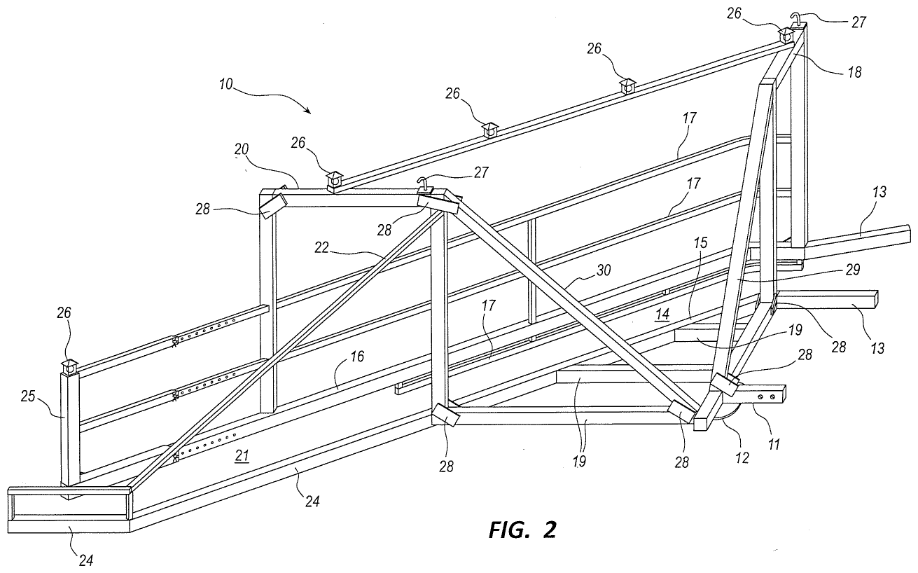

FIG. 2 provides a perspective view opposite of the view provided in FIG. 1. Hitch attachment 11 and hitch reinforcement plate 12 attach to horizontal supports 19, which attach to interior guide rail 15. Entry gate support 29 attaches to horizontal support 19 and entry gate 18. Exit gate support 30 attaches to horizontal support 19 and exit gate 20. Intake guides 13 extend outward from entry gate 18 to enable the capture of a desired traffic safety device. Once the traffic safety device is captured, it passes through entry gate 18 into guide chute 14 through exit gate 20 into ejection 21 and past ejection guide 24 and ejection chute guide 25 to the desired final placement. A traffic safety device that is captured within guide chute 14 traffic safety device placement apparatus 10 is supported by entry gate 18, interior guide rail 15, exterior guide rail 16 and inner support rails 17, which enables a worker to drive the vehicle to which traffic safety device placement apparatus 10 is attached at higher speed, thus enabling the placement of traffic safety devices to be completed more quickly than using previous known devices. It takes only two minutes to set one mile of barrels using the present invention.

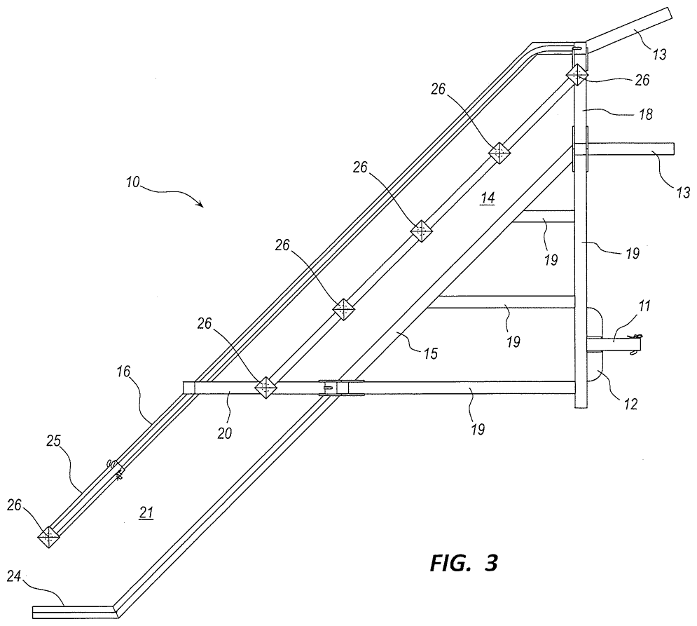

FIG. 3 is a top view of traffic safety device placement apparatus 10. When traffic safety device placement apparatus 10 is attached to the existing hitch on a vehicle, intake guides 13 extend outward from the vehicle so that the vehicle has adequate clearance to approach a traffic safety device without hitting the traffic safety device with the vehicle. A captured traffic safety device slides through entry gate 18 along guide chute 14 through exit gate 20 into ejection chute 21 and is placed precisely where desired using the adjustability of ejection guide 24 and ejection chute guide 25.

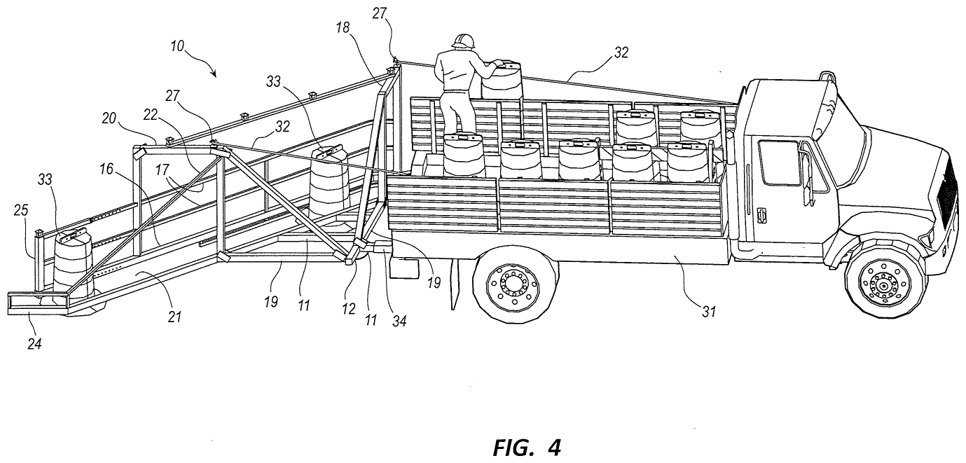

FIG. 4 shows traffic safety device placement apparatus 10 attached to a vehicle 31. Support straps 32 are connected between vehicle 31 and traffic safety device placement apparatus 10 using strap support hooks 27. FIG. 3 shows traffic safety device placement apparatus 10 being used for the initial placement of traffic barrels 33. Hitch attachment 11 is inserted to existing hitch 34 on the back of vehicle 31. In this case, worker 35 lowers traffic barrels 33 off of the side of vehicle 31 to the roadway. Once a traffic barrel 33 is on the ground, it enters traffic safety device placement apparatus 10 via intake guides 13 through entry gate 18, where it impacts exterior guide rail 16, inner support rails 17 and interior guide rail 15 as it enters guide chute 14. Nylon or other suitable material may be affixed to the members that define guide chute 14 to assist with the smooth transition of traffic barrel 33 from entry gate 18 through guide chute 14 through exit gate 20 into ejection chute 21 and to final placement. Once the barrels have been initially placed, there is no longer a need for worker 35 to place the barrels. Instead, a single worker drives vehicle 31 along the roadway to capture the previously placed traffic barrels 33 and move the barrels into or out of the roadway. It is the subsequent moving of barrels at the start and each day of a project that is completed much more quickly and safely than it has ever been done before using previous devices.

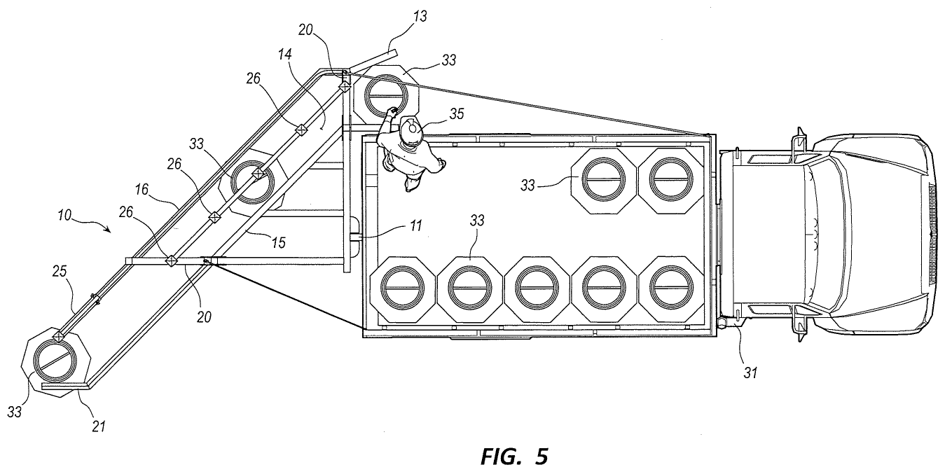

FIG. 5 provides a top view of the configuration for the initial placement of traffic barrels. Worker 35 is located within the bed of vehicle 31 and lowers traffic barrels 33 onto the roadway. In this view, a traffic barrel 31 is entering traffic safety device placement apparatus 10 via the intake guides and entry gate 18. Another traffic barrel 33 is located within guide chute 14, while another traffic barrel is being precisely placed as it leaves ejection chute 21 past adjustable ejection chute guide 25 and ejection guide 24. Traffic safety device placement apparatus 10 is attached to vehicle 31 by hitch attachment 11 and support straps 32. Once the traffic barrels are initially placed, there is no longer a need for worker 35 to be present in the bed of vehicle 31. A single worker can drive vehicle 31 with traffic safety device placement apparatus 10 attached to move the barrels into or out of the roadway.

The traffic safety device placement apparatus of the present invention can also be configured to attach to a vehicle in such a manner that it captures and moves traffic safety devices from the passenger side of a vehicle to the driver side of a vehicle.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention.

What is claimed is:

1. A retrofitable traffic safety device placement apparatus removably attached to a vehicle, comprising:
an attaching device for removably attaching said apparatus to a vehicle;
an intake end for receiving a traffic safety device;
a transfer chute connected to said intake end wherein said traffic safety device moves through said transfer chute; and
an ejection end connected to said transferring chute wherein said traffic safety device is permitted to exit said apparatus for placement onto or off a roadway.

2. The apparatus of claim 1 wherein said transfer chute is comprised of guide rails located on opposite sides of said transfer chute enabling said traffic safety device to pass between said guide rails.

3. The apparatus of claim 2 wherein said guide rails are coated with friction reducing material.

4. The apparatus of claim 1 wherein said transfer chute is located at a 30 degree to 50 degree angle relative to said vehicle.

5. A method for placing traffic safety devices comprising:
removably attaching an attaching device to the existing receiver hitch of a vehicle;
capturing traffic safety devices within an intake end connected to said attaching device;
moving said traffic safety devices through a transfer chute connected to said intake end; and
ejecting said traffic safety devices from an ejection end connected to said transfer chute to a desired location.

6. A traffic safety device placement apparatus removably attached to a vehicle, comprising:
an attaching device for removably attaching said apparatus to a vehicle;
an intake end for receiving a traffic safety device;
a transfer chute connected to said intake end wherein said traffic safety device moves through said transfer chute; and
an ejection end connected to said transferring chute wherein said traffic safety device is permitted to exit said apparatus for placement onto or off a roadway.

7. A traffic safety device placement apparatus attached to a vehicle, comprising:
an attaching device for attaching said apparatus to a vehicle;
an intake end for receiving a traffic safety device;
a transfer chute connected to said intake end wherein said traffic safety device moves through said transfer chute; and
an ejection end connected to said transferring chute wherein said traffic safety device is permitted to exit said apparatus for placement onto or off a roadway.
